(19) United States
(12) Patent Application Publication
(10) Pub. No.: US 2025/0035068 A1
(43) Pub. Date: Jan. 30, 2025

(54) HIGH-POWER HYBRID-ELECTRIC PROPULSION SYSTEMS AND METHODS

(71) Applicant: ePropelled Inc., Gilford, NH (US)

(72) Inventors: Narotam Singh GREWAL, Sanbornton, NH (US); Nabeel SHIRAZEE, Cardiff (GB)

(73) Assignee: ePropelled Inc., Gilford, NH (US)

(21) Appl. No.: 18/715,796

(22) PCT Filed: Dec. 2, 2022
(86) PCT No.: PCT/US2022/080845

§ 371 Date: Jun. 3, 2024

(30) Foreign Application Priority Data
Dec. 3, 2021 (IN) 202141056236

(51) Int. Cl. F02K 1/38; B64D 27/02; B64D 27/16; B64D 27/33; F23R 3/28

(52) U.S. Cl. CPC F02K 1/38; B64D 27/026; B64D 27/16; B64D 27/33; F23R 3/286

(57) ABSTRACT

Disclosed herein are high-power hybrid electric jet propulsion systems and methods for creating thrust using electric propulsion and chemical reaction. Embodiments include powering a Stage1 (6) electric machines (6b) through motor controllers for spinning a shaft (5), which spins a fan (2) to draw in air through the engine cowl (1) into Stage1 (6) where it gets compressed and heated. The air is then passed into a cyclonic combustion chamber (7) for mixing with a fuel to create a medium (X1). The medium (X1) is then passed into the turbine blades (8a) in Stage2 (8) to the spin shaft (5). The shaft (5) is configured to produce the high bypass thrust (10) and the jet exhaust thrust (9).

### FIELD OF THE INVENTION

The present invention relates generally to hybrid-electric propulsion systems employed in vehicles.

### BACKGROUND

The aviation industry is working towards reducing both fuel consumption and carbon emissions, as they contribute about 2.1 to 2.4% of carbon emissions globally and 12% of CO2 emissions from all transport sources as they burn gasoline/kerosene-based fuel. A typical large passenger jet has emissions of around 90 kg CO2 per passenger/hour. This is generally emitted into the high atmosphere and has a greater CO2 impact than CO2 released at sea level. For example, at sea levels, this could be 180 kg CO2 per passenger/hour.

This will increase in the future as aviation is one of the fast-growing sectors, particularly if improvements are not made to jets of all kinds. Further current fossil fuel jet propulsion engines are inefficient, and loud, and burn fossil fuels in huge quantities. Fossil fuels are mainly composed of coal, oil, and natural gas. The burning of fossil fuels results in the emission of greenhouse gases like carbon dioxide which affects our planet and every living thing on it. A growing number of countries have committed to becoming carbon neutral in 2050. This has led to the pursuit of alternative ways to improve energy efficiency and reduce carbon emissions.

Some other proposed technologies, systems and methods have been suggested for reducing the emission of greenhouse gases from aircraft engines. For example, Chinese patent number 107,842,442 discloses an aircraft engine comprising an air intake channel, a gas compressor, a combustion chamber, a motor, a jet pipe, and a thermojet magnetic electrical device. The air enters the gas compressor and passes through the combustion chamber after being compressed. The airflow is exhausted through the jet pipe after combustion. The airflow is used by a thermojet magnetic electrical device for generating electricity, and the motor is used for driving the gas compressor.

Despite improvements in technologies related to systems and methods used in transportation for reducing the emission of greenhouse gases into the atmosphere, there is still a need for an effective system and method which not only eliminates the emission of greenhouse gases into the atmosphere but also improves the energy efficiency of the aviation system.

An object of the present invention is to provide a hybrid electric jet propulsion system and methods for creating thrust using a combination of electric propulsion and chemical reaction in an aircraft hybrid engine.

Another object of the present invention is to provide methods that improve the energy efficiency of the hybrid electric jet propulsion system used in an aircraft and/or that reduce or eliminate carbon emissions into the environment.

### SUMMARY

The proposed system uses a combination of electric machines turbines and propulsion machines (e.g., plasma, ions, hydrogen, fossil fuel or other non-fossil-based fuel) to spin the shaft in power-assist mode thereby creating an efficient propulsion system for aircraft, which can reduce and/or eliminate carbon emissions. The proposed system may achieve net-zero CO2 emissions for a vehicle. The proposed method is efficient compared to a conventional jet engine, which emits high CO2 emissions.

According to embodiments consistent with the present invention, the high-power hybrid electric jet propulsion system comprises an engine cowl, the main fan which is connected to a gearbox, an inner cowl, a main shaft coupled to the gearbox, a Stage1 which includes a plurality of electric machines and turbine blades, a cyclonic combustion chamber, a Stage2 which includes turbine blades. Each electric machine in Stage1 comprises a set of turbine blades which are mounted on the rotor of the electric machine whereas in Stage2 the turbine blades are mounted on a disc as in a conventional jet engine. Stage1 can be considered to be a first stage. Stage2 can be considered to be a second stage.

In accordance with embodiments consistent with the present invention, the method for creating a high thrust using the high-power hybrid electric jet propulsion system comprises the following steps: powering Stage1 electric machines by a plurality of motor controllers (not shown) to spin the main shaft which runs longitudinally along the electric machines and coupled to the gearbox positioned at the front end of the propulsion system, spinning the main fan through a gearbox mechanism, drawing in air through the engine cowl where part of the air from the main fan also passes through an inner cowl and into the set of turbine blades mounted on plurality of electric machines in Stage1, heating and compressing the incoming air to around 40 times and passing the highly compressed air from Stage1 to a cyclonic combustion chamber for mixing with non-fossil-based fuel, combusting the mixture to create a heated medium which is then passed through the set of turbine blades mounted on the disc in Stage2 and assisting the shaft to spin faster by the medium in Stage2. The medium may be compressed and/or fast flowing. The heated medium passing through the turbine blades of Stage2 increases the speed of these turbine blades to spin the shaft faster thereby enabling the power-assist mode to the electric machines in Stage1. This then uses the flow of bypass air creating nearly 80% of the thrust needed for the aircraft.

In accordance with embodiments consistent with the present invention, methods and systems disclosed herein create thrust using electric and chemical reactions and spin the main shaft, which can be connected to a fan via a gearbox, where the fan draws in air to produce the thrust. Some engines may not have any gearbox and be a direct drive system.

In accordance with embodiments consistent with the present invention, a jet engine may include multiple stages of stacked-up electric machines and a cyclonic combustion chamber to create hybrid electric propulsion. The cyclonic combustion chamber can include a fossil fuel or any non-fossil-based fuels disclosed herein as a catalyst to create an enhanced chemical reaction. In some embodiments, this reaction contributes to at least 20% of the thrust and the remaining thrust can be generated by the bypass air. Thrust is produced by a spinning fan and the turbine stages by gases expelled through the rear of the engine.

In accordance with embodiments consistent with the present invention, a hybrid electric jet propulsion system may comprise an engine cowl configured to direct air into the main fan which is connected to a gearbox; a main shaft coupled to the gearbox; an inner cowl configured to receive the air from the main fan and configured to direct it to a first stage, wherein the first stage is configured to compress the air, wherein the first stage comprises one or more electric machines; a cyclonic combustion chamber for mixing fuel with air from the first stage and combusting the mixture; and a second stage configured to receive the medium from the cyclonic combustion chamber to spin the main shaft, wherein the second stage comprises a second set of turbine blades, wherein the first stage is configured to continue to spin the main shaft if the combustion of the mixture does not supply power to the main shaft.

According to some embodiments, the first stage may comprise a compressor. According to some embodiments, the turbine blades and rotor of the electric machines may be made of one piece using additive manufacturing. According to some embodiments, the fuel used in the cyclonic combustion chamber may include plasma, ions, hydrogen, or a non-fossil-based fuel. According to some embodiments, at least one of the electric machines of the first stage may be configured to act as a generator. According to some embodiments, the first stage may be sufficient to spin the main shaft if combustion does not occur. According to some embodiments, the air may be tangentially fed into the cyclonic combustion chamber. According to some embodiments, thrust may be produced by a first expelled air from a bypass stage and a second expelled air from a combustion stage.

The above-mentioned methods and systems are not only energy efficient but also reduce and/or eliminate carbon emissions, which is beneficial for the environment. This system is energy efficient because the electric propulsion system providing as much as 80% of the thrust can operate efficiently. For example, the efficiency may be above 95% efficiency during flight. This is a significant increase from a conventional jet engine where the overall efficiency ranges between 20 and 40%.

These objectives and advantages will become more evident from the following detailed description when taken in conjunction with the accompanying drawings.

### BRIEF DESCRIPTION OF THE DRAWINGS

The accompanying drawings, which are incorporated in and constitute a part of this specification, illustrate multiple embodiments of the presently disclosed subject matter and, together with the description, serve to explain the principles of the presently disclosed subject matter; furthermore, are not intended in any manner to limit the scope of the presently disclosed subject matter.

FIG. 1 shows a cross-sectional view of an embodiment of a proposed high-power hybrid electric propulsion system in an aircraft; and

FIG. 2 shows a third-angle view of an embodiment of a hybrid electric propulsion system.

### DETAILED DESCRIPTION

Disclosed herein are systems and methods for a hybrid electric jet propulsion system and for creating thrust using electric propulsion and chemical reaction. The proposed systems and methods use a combination of electric machines and turbine blades to create a power-assisted and efficient propulsion system for aircraft, which reduces and/or eliminates carbon emissions. The proposed method is more energy efficient than a conventional jet engine.

According to embodiments consistent with the present invention, the high-power hybrid electric jet propulsion system comprises an engine cowl, a main fan connected to a gearbox, an inner cowl, a main shaft coupled to the gearbox, a Stage1 having a plurality of electric machines and turbine blades, an intermediate cyclonic combustion chamber and a Stage2 having a plurality of turbine blades, electric machine in Stage1 comprises a set of turbine blades which are mounted on the rotor of the electric machine. The ingested air from the atmosphere (e.g., relatively cold air) can pass through the main fan and the turbine blades at Stage1 and be compressed. The compressed air can be mixed with fuel in the cyclonic chamber. The mixture may be combusted in the chamber to create a heated medium. Depending on the location of the medium, the medium may be of high velocity and/or high pressure. The hot medium can be passed to Stage2 to create a thrust that can spin the main shaft.

The clearance between the turbine blade and the inner cowl can be small to maintain high efficiency, e.g.: 1 mm

In accordance with embodiments consistent with the present invention, the method for creating thrust using the high-power hybrid electric jet propulsion system comprises the following steps: powering Stage1 electric machines by one or more motor controllers positioned on top or near one or more electric machines. One or more electric machines spin the main shaft connected to a gearbox thereby spinning the main fan attached to the gearbox. The gearbox can be positioned at the front end of the hybrid electric propulsion system. Air can be drawn in by the main fan from outside (e.g., an atmosphere). The air may be drawn through an engine cowl to an inner cowl. The air may pass in between a turbine or a set of turbine blades mounted on an electric machine or a plurality of electric machines, respectively, in Stage1. The air may heat due to friction and compression to about 500° C. The air from Stage1 may then pass into a cyclonic combustion chamber to mix with fuels for combustion. The fuel may be fossil-based or non-fossil based. The combusted gas can create a heated medium which then passes through the turbine or the set of turbine blades in Stage2. The medium can move the main shaft (e.g., to spin) or can move the main shaft faster (e.g., spin faster). The exiting exhaust gas from Stage2 can provide up to 20% thrust. The hot medium and the Stage2 turbine blades contribute powerassist to the electric propulsion system.

Reference will now be made to the figures disclosed herein:

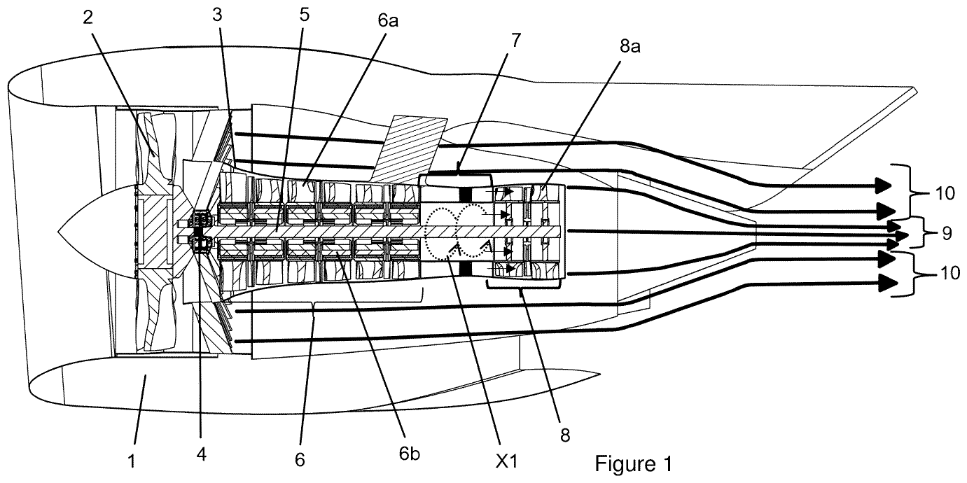

FIG. 1 shows the cross-sectional view of the proposed hybrid electric propulsion system. The system can comprise an engine cowl (1) which draws the air from the atmosphere through the main fan (2). The main fan (2) may be connected to the gearbox (4). The gearbox (4) may be connected to the main shaft (5). The main shaft (5) may spin through the centre of the hybridelectric propulsion system. The inner cowl (3) may direct the air through Stage1 (6). The main fan (2) may be driven by the mam shaft (5) through the gearbox (4). Gearbox (4) may be capable of a single gearing ratio between the main fan (2) and the main shaft (5) or multiple gearing ratios that can be switched. In some embodiments, the main fan (2) may be connected directly to main shaft (5). The ratios of gearbox (4) may include 15:1 and/or 30:1.

Stage1 (6) comprises a plurality of electric machines (6b). Each of the machines can include a set of turbine blades (6a) mounted onto the respective rotors. The air (e.g., at an ambient air temperature) that enters Stage1 (6) can be compressed and heated. In some embodiments, the air may be compressed and/or heated over 40 times as it passes through the multi-stage turbine blades (6a). The temperature of the heated air may increase to about 500° C. after compression. The air can be tangentially fed into the cyclonic combustion chamber (7). In some embodiments, one or more turbine blades (6a) and/or ducts or fixed turbines may be configured to feed the air and/or fuel into the cyclonic combustion chamber (7) tangentially. Feeding the air tangentially creates a cyclonic effect inside the chamber as it narrows. Combustion may accelerate this process and increase the speed.

In some embodiments, electric machines (6b) may comprise a rotor that is a part of or connected to main shaft (5), and a stator positioned inside or outside of the rotor. One or more permanent magnets and/or windings may be mounted to the rotor and/or stator such that the main shaft (5) may be rotated or such that the main shaft (5) generates electric power. In some embodiments, electric machines (6b) may be axial flux or radial flux machines, with or without permanent magnets. In some embodiments, an outside of the rotors of electric machines (6b) may comprise or be connected to turbine blades (6a). Electric machines (6b) may be electrically connected to one or more batteries and/or fuel cells.

In some embodiments, electric machines (6b) may be positioned outside of Stage1 (6) and may be mechanically connected to main shaft (5) to supply and/or receive mechanical energy to or from main shaft (5). Electric machines (6b) may be directly connected to main shaft (5) or through one or more gears (e.g., in a gearbox).

In accordance with embodiments consistent with the present invention, the electric machines may comprise one or more fixed radial turbine blades in addition to rotating radial turbine blades (e.g., part of or connected to rotors or connected to the mam shaft (5)). Fixed and rotating turbine blades can help in compressing air in Stage1 (6) electric machines. Fixed longitudinal blades may be included to direct air along a duct.

In accordance with embodiments consistent with the present invention, the blades of the turbine (8a) may be at least partially coated with a material such as industrial diamond to withstand high temperatures, high pressures, and/or combustion or flow irregularities during Stage2 (8), as the temperature extends to around 2000° C. or more. Other cooling methods may be used to prevent metals from melting after coming into contact with the medium (X1).

In accordance with embodiments consistent with the present invention, the profiles of the turbine blades (6a) may be shorter in length as compared to conventional jet engines as the electric motors may spin at speeds of 40,000 to 100,000 rpm. The electric machines may be configured so as to reduce the size of the hybrid electric propulsion system. The active material (e.g., size of turbine blades, shafts, or other components) used in Stage1 may be reduced.

The turbine blades (6a, 8a) and/or the rotor of the electric machines (6b) may be constructed in one piece using additive manufacturing. For example, material may be sequentially layered to form turbine blades (6a, 8a) and/or the rotor of the electric machines (6b). The turbine blades (6a, 8a) and/or the rotor of the electric machines (6b) may be mounted on a main shaft (5).

In the cyclonic combustion chamber (7), the plasma or ions or any of the non-fossil-based fuel is tangentially injected into the incoming highly compressed air discharged from Stage1 (6) to create a mixture, which is then ignited. This creates a super-heated fast-flowing medium (X1) (up to 2000° C.) which is then passed through Stage2 (8).

In accordance with embodiments consistent with the present invention, any one or all of the Stage1 electric machines can act as a generator to create electric power.

In accordance with embodiments consistent with the present invention, the fuel used in the cyclonic combustion chamber (7) can be plasma, ion, hydrogen, fossil fuel-based or any non-fossil-based fuel which has high energy efficiency.

In accordance with embodiments consistent with the present invention, the combustion chamber (7) does not operate in a cyclonic manner, i.e., the highly compressed air flows into the combustion chamber (7) and is then mixed with the fuel. The mixture is then ignited and combusted to create a super-heated fast-flowing medium (X1).

The hot medium (e.g., heated to 2000° C. or more) can be expelled through the Stage2 (8) turbine blades (8a), which spins faster which in turn can spin the main shaft faster.

In accordance with embodiments consistent with the present invention, the hot medium and the Stage2 (8) turbine blades contribute to the power-assist aspect to spin the shaft faster.

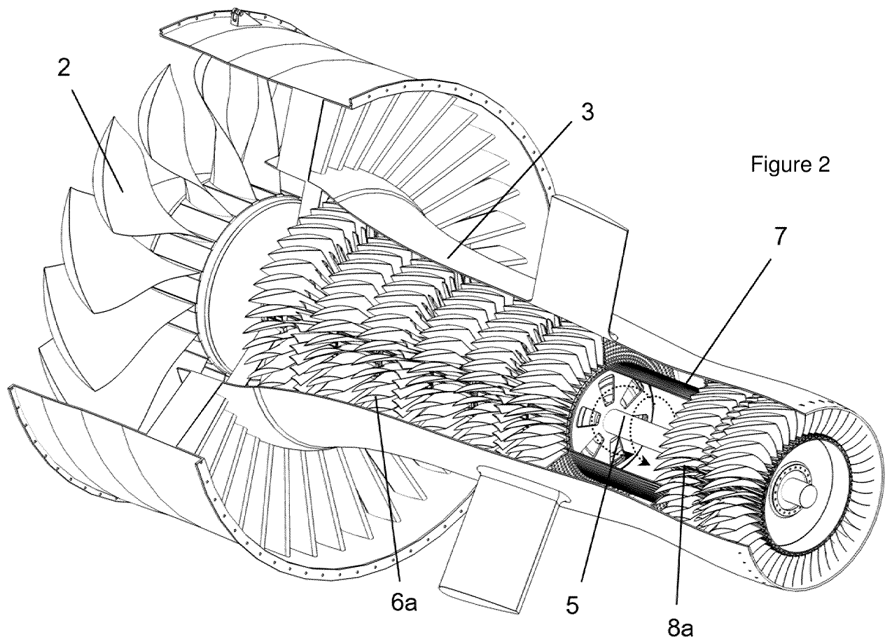

Also, the third-angle view of the proposed hybrid electric propulsion system is shown in FIG. 2.

The hybrid electric propulsion system can comprise one or more motor controllers (e.g., one or more variable speed drive inverters) comprises embedded firmware that controls the motor efficiently and provides power to the Stage1 (6) electric machines to spin the main shaft (5). The one or more controllers may command the one or more electric motors to spin the main shaft (5), to brake the main shaft (5), to speed up, to slow down, and/or to generate power from the main shaft (5). The main shaft (5) runs longitudinally along the electric machines (6b) and can be coupled to the gearbox (4). The gearbox (4) can be positioned at the front end of the propulsion system. The gearbox may be configured to spin the mam fan (2). The mam fan (2) can pull in air (e.g., from the atmosphere) through the engine cowl (1). The air (e.g., at ambient temperature) can pass through the sets of turbine blades (6a) mounted on electric machines (6b) of Stage1 (6). The air can become compressed and heated in Stage1 (6). The air can become compressed as a result of power applied to the main shaft (5) by the electric machines (6b). For example, one or more motor controllers can command electric machines (6b) to drive main shaft (5) to begin compressing air in Stage1 (6). In some embodiments, such compression can be used to start up an engine so that combustion can begin.

The air can pass to the cyclonic combustion chamber (7). Fuel can be mixed with the air in the cyclonic combustion chamber (7) for combustion. In the cyclonic combustion chamber (7), the air (e.g., heated to around 500° C.) can be tangentially passed. The air can be mixed with the fuel which may also be sprayed tangentially. This mixture can then be ignited by a circular ignition system (e.g., using a spark or flame) (not shown) to start the combustion reaction process. The combustion may thereafter be self-sustaining. This combustion can create a hot medium (e.g., heated to around 2000° C.).

In some embodiments, the hot medium can then be fed into the turbine blades (8a) in Stage2 (8). The cyclonic combustion chamber (7) can have profiles towards the end of the chamber (7) to guide the medium (X1) (e.g., in linear motion) as it exits the cyclonic combustion chamber (7) to Stage2 (8). The cyclonic effect can allow the cyclonic combustion chamber (7) to be short in length and may provide sufficient back pressure to produce forward thrust. The medium (X1) can be pushed to the turbine blades (8a) in Stage2 (8) to spin faster in power-assist mode thereby making the main shaft (5) spin faster.

The electric power, by command of the motor controller, can be provided to the electric machines (6b) to spin the main fan (2) efficiently in addition to the power assist provided by the medium (X1) when it passes through turbine blades (8a) of Stage2 (8). The electric power can be continuous, periodic, intermittent, or shut off. The medium (X1) may be discharged as air (9). The electrical power and the power from combustion can be controlled to produce optimum efficiency during different stages of an aircraft's movement (e.g., during taxiing, take-off, cruising, and landing). In some embodiments, the electric machines (6b) may be powered by the electric power to begin compressing air to start spinning of the main shaft (5).

In accordance with embodiments consistent with the present invention, the electric power may be supplied by one or more batteries. In some embodiments, the electric power may be generated by a hydrogen fuel cell.

In accordance with embodiments consistent with the present invention, electric power may be generated by rotation of main shaft (5) and supplied to one or more batteries. Electric power may be generated by electric machines (6b). In some embodiments, power may be generated through main shaft (5) to store electric power, and the electric power may be expelled through main shaft (5) to generate thrust. One or more motor controllers may determine to store or use electric power using the one or more electric machines (6b) based on the afore-mentioned stages of an aircraft's movement. For example, stored electric power may be used by electric machines (6b) to spin main shaft (5) if combustion is not being used or during start-up. As another example, electric power may be generated by electric machines (6b) to be stored when combustion is being used.

In accordance with embodiments consistent with the present invention, a hybrid-electric system can include turbine blades that spin the main fan (2). For example, the main fan (2) may spin at a 20:1 gear ratio. A conventional jet engine may typically spin around 20,000 to 40,000 rpm. For embodiments consistent with the present invention, an exemplary engine can spin around 40,000 to 100,000 rpm. Disclosed embodiments may be used to reduce the size, a number of components, and the complexity relative to conventional propulsion systems. Disclosed embodiments may reduce aspects of components of a propulsion system compared to conventional systems such as the size of components (e g, turbine blades, shafts, and other components including those that contribute to the generation of thrust), the number of components, and complexity of the component.

The fuel may be sprayed via an array of nozzles positioned on the inside of the outer periphery of the combustion chamber.

For conventional jet engines, large amounts of rain and/or hail can stop a jet engine from operating. This can be dangerous for aircraft including those jet engines. However, in the present invention, if the cyclonic combustion chamber (7) flames out due to rain, hail, or other conditions as would be known by one of ordinary skilled in the art, the Stage1 (6) electric machines (6b) may continue to operate and/or spin the main shaft (5). Stage1 may provide sufficient power such that thrust is produced by the main fan (2). The resultant thrust may be sufficient to allow the aircraft to continue to fly (e.g., while still producing some thrust from the propulsion system).

In a similar manner, the combustion chamber (7) and Stage2 (8) may provide sufficient power to spin the main shaft (5) to continue flying the aircraft during failure of the motor controller or electric machines (6b) of Stage1 (6). Both, Stage1 (6) and the combination of combustion chamber (7) and Stage2 (8) are independent of each other, thereby dramatically increasing the reliability of such an engine by at least 2 time than conventional jet engines. Embodiments consistent with the present invention may have a high power-to-weight ratio and/or a high thrust-to-weight ratio when compared to conventional jet engines.

In some embodiments, the electric machines can be one of several types namely, a permanent magnet synchronous machine type, a synchronous reluctance machine type, a radial type, an axial type, an inner rotor type, or an outer rotor type. Synchronous reluctance machines may include no magnets. Synchronous machines may include no magnets and include wound rotor.

In some embodiments, the proposed system can be manufactured using up to 20% fewer materials compared to conventional jet engines, which reduces the need for expensive and rare materials.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope of the invention as claimed.

1. A hybrid electric jet propulsion system for creating thrust in an aircraft engine, wherein the system comprises:
a. an engine cowl (1) for directing air into the main fan (2) which is connected to a gearbox (4);
b. a main shaft (5) connected to the gearbox (4);
c. an inner cowl (3) for receiving the air from the main fan (2) and directing it to a Stage1 (6) for compression wherein the Stage1 (6) comprises:
i. one or more electric machines (6b) each comprising a rotor, wherein the one or more electric machines are driven by a motor controller; and
ii. a first set of turbine blades (6a) mounted on each rotor;
d. a cyclonic combustion chamber (7) for mixing a fuel with air from the Stage1 (6) and combusting the mixture into a medium (X1); and
e. a Stage2 (8) for receiving the medium (X1) from the cyclonic combustion chamber (7) to assist in spinning the main shaft (5), wherein the Stage2 (8) comprises:
i. a second set of turbine blades (8a).

2. The system as claimed in claim 1, wherein Stage1 (6) is configured as a compressor.

3. The system as claimed in claim 1, wherein the turbine blades (6a) and rotor of the electric machines (6b) are made in one piece using additive manufacturing.

4. The system as claimed in claim 1, wherein the fuel used in the cyclonic combustion chamber (7) includes plasma, ions, hydrogen, or a non-fossil-based fuel.

5. The system as claimed in claim 1, wherein the electric machines (6b) of Stage1 (6) are configured to act as a generator.

6. The system as claimed in claim 1, wherein Stage1 (6) is standalone to spin the main shaft (5) and provide thrust if combustion does not occur.

7. The system as claimed in claim 1, wherein the combustion chamber (7) and Stage2 (8) are standalone to spin the main shaft (5) and provide thrust if the motor controllers or electric machines in Stage1 fails.

8. The system as claimed in claim 1, wherein the air is tangentially fed into the cyclonic combustion chamber (7)

9. The system as claimed in claim 1, wherein the fuel is tangentially fed into the cyclonic combustion chamber (7).

10. A method for creating thrust in aircraft using a hybrid electric jet propulsion system, wherein the method comprises the steps:
a. Powering of Stage1 (6) electric machines (6b) by motor controllers, wherein Stage1 (6) is configured to spin the main shaft (5) connected to a gearbox (4) positioned fore towards an intake (1);
b. spinning the gearbox (4) coupled to the main fan (2) to pull in air through an engine cowl (1);
c. directing the air from the main fan (2) through an inner cowl (3) and passing it through Stage1 (6) comprising a first set of turbine blades (6a) mounted on a plurality of electric machines (6b);
d. heating and compressing the air in Stage1;
e. receiving the air from the Stage1 (6) into the cyclonic combustion chamber (7) for mixing with fuel and igniting the mixture into a medium (X1);
f. passing the medium (X1) from the cyclonic combustion chamber (7) into Stage2 (8) comprising a second set of turbine blades (8a), wherein the second set of turbine blades is configured to assist in spinning main shaft (5) faster;
g. spinning the main shaft (5) by discharging air (9); and
h. spinning the main shaft (5) by discharging air (10).

11. The method as claimed in claim 7, wherein the temperature of air in Stage1 reaches or exceeds 500° C.

12. The method as claimed in claim 7, wherein the temperature of medium (X1) in Stage2 reaches or exceeds 2000° C.

13. The method as claimed in claim 7, wherein Stage1 (6) is standalone to spin the main shaft (5) and provide thrust if combustion does not occur.

14. A hybrid electric jet propulsion system comprising: a. an engine cowl (1) configured to direct air into the main fan (2) which is connected to a gearbox (4); b. a main shaft (5) coupled to the gearbox (4); c. an inner cowl (3) configured to receive the air from the main fan (2) and configured to direct it to a first stage (6), wherein the first stage (6) is configured to compress the air, wherein the first stage (6) comprises one or more electric machines (6b); d. a cyclonic combustion chamber (7) for mixing fuel with air from the first stage (6) and combusting the mixture; and e. a second stage (8) configured to receive the medium (X1) from the cyclonic combustion chamber (7) to spin the main shaft (5), wherein the second stage (8) comprises a second set of turbine blades (8a), wherein the first stage is configured to continue to spin the main shaft (5) if the combustion of the mixture does not supply power to the main shaft (5).

15. The system as claimed in claim 13, wherein the first stage (6) comprises a compressor.

16. The system as claimed in claim 13, wherein the turbine blades (6a) and rotor of the electric machines (6b) are made in one piece using additive manufacturing.

17. The system as claimed in claim 13, wherein the fuel used in the cyclonic combustion chamber (7) includes plasma, ions, hydrogen, or a non-fossil-based fuel.

18. The system as claimed in claim 13, wherein at least one of the electric machines (6b) of the first stage (6) is configured to act as a generator.

19. The system as claimed in claim 13, wherein the first stage (6) is sufficient to spin the main shaft (5) if combustion does not occur.

20. The system as claimed in claim 13, wherein the air is tangentially fed into the cyclonic combustion chamber (7).

21. The system as claimed in claim 13, thrust may be produced by a first thrust (10) from a bypass and a second thrust (9) from the second stage (8).
